(19) United States
(12) Patent Application Publication
(10) Pub. No.: US 2024/0348000 A1
(43) Pub. Date: Oct. 17, 2024

(54) OPTICAL AMPLIFICATION SYSTEM, OPTICAL AMPLIFICATION METHOD, AND STORAGE MEDIUM

(71) Applicant: NEC Corporation, Minato-ku, Tokyo (JP)

(72) Inventor: Toshifumi Nakamura, Tokyo (JP)

(73) Assignee: NEC Corporation, Minato-ku, Tokyo (JP)

(21) Appl. No.: 18/293,028

(22) PCT Filed: Aug. 11, 2021
(86) PCT No.: PCT/JP2021/029644

§ 371 Date: Jan. 29, 2024

(51) Int. Cl. H01S 3/10; H01S 3/067

(52) U.S. Cl. CPC H01S 3/10038; H01S 3/06754

(57) ABSTRACT

An optical amplification system includes: optical output circuits to output excitation light; optical amplifiers to amplify an optical signal; a power consumption measurement circuit to measure power consumption consumed by the optical output circuits; an excitation light measurement circuit to measure intensity of the excitation light output from each of the optical output circuits; a first optical signal measurement circuit to measure first intensity of the optical signal before amplification; a second optical signal measurement circuit to measure second intensity of the optical signal after amplification; a first calculator to calculate a radiation efficiency of the optical output circuits; a second calculator to calculate an excitation efficiency of the optical amplifiers; and a connection circuit to connect between each of the optical output circuits and each of the optical amplifiers.

### TECHNICAL FIELD

The present invention relates to, for example, an optical amplification system and the like capable of amplifying an optical signal by a plurality of optical amplification means.

### BACKGROUND ART

In recent years, a method of amplifying an optical signal propagating through each core within a multicore optical fiber is known. For example, PTL 1 discloses a technique for controlling output power of laser light in order to excite a core of a multicore optical fiber.

### CITATION LIST

### Patent Literature

PTL 1: Japanese Translation of PCT International Application Publication No. 2020-513162

### SUMMARY OF INVENTION

### Technical Problem

However, within a multicore optical fiber, even when the same intensity of excitation light is input to a plurality of cores, an amount of amplification differs between the cores due to placement of the cores or an error occurring during manufacturing. Further, also in a light source that outputs excitation light, even when the same amount of electric power is supplied to a plurality of light sources, intensity of excitation light being output from the light source may differ between the light sources due to an error occurring during manufacturing.

As described above, a plurality of cores or light sources have mutually different characteristics such as an amount of amplification, even when having the same specification. Thus, for example, there is a problem that attempting to excite a core having a low amount of amplification by a light source that outputs excitation light having low intensity results in high power consumption.

The present invention has been made in view of the above-described problem, and an object of the present invention is to provide an optical amplification system and the like capable of reducing power consumption.

### Solution to Problem

An optical amplification system according to the present invention includes:

a plurality of optical output means for outputting excitation light;

a plurality of optical amplification means for amplifying an optical signal according to the excitation light;

a power consumption measurement means for measuring power consumption being consumed by each of the plurality of optical output means;

an excitation light measurement means for measuring intensity of the excitation light being output from each of the plurality of optical output means;

a first optical signal measurement means for measuring first intensity of the optical signal before amplification by the optical amplification means;

a second optical signal measurement means for measuring second intensity of the optical signal after amplification by the optical amplification means;

a first calculation means for calculating a radiation efficiency of the optical output means, based on the power consumption and the intensity of the excitation light;

a second calculation means for calculating an excitation efficiency of the optical amplification means, based on the first intensity, the second intensity, and the intensity of the excitation light; and

a connection means for connecting between each of the optical output means and each of the optical amplification means, based on the radiation efficiency and the excitation efficiency.

Further, an optical amplification method according to the present invention includes:

outputting excitation light by a plurality of optical output means;

amplifying an optical signal according to the excitation light by a plurality of optical amplification means;

measuring power consumption being consumed by each of the plurality of optical output means;

measuring intensity of the excitation light being output from each of the plurality of optical output means;

measuring first intensity of the optical signal before amplification by the optical amplification means;

measuring second intensity of the optical signal after amplification by the optical amplification means;

calculating a radiation efficiency of the optical output means, based on the power consumption and the intensity of the excitation light;

calculating an excitation efficiency of the optical amplification means, based on the first intensity, the second intensity, and the intensity of the excitation light; and

connecting between each of the optical output means and each of the optical amplification means, based on the radiation efficiency and the excitation efficiency.

Further, a storage medium according to the present invention stores a program causing an information processing device to execute processing of:

outputting excitation light by a plurality of optical output means;

amplifying an optical signal according to the excitation light by a plurality of optical amplification means;

measuring power consumption being consumed by each of the plurality of optical output means;

measuring intensity of the excitation light being output from each of the plurality of optical output means;

measuring first intensity of the optical signal before amplification by the optical amplification means;

measuring second intensity of the optical signal after amplification by the optical amplification means;

calculating a radiation efficiency of the optical output means, based on the power consumption and the intensity of the excitation light;

calculating an excitation efficiency of the optical amplification means, based on the first intensity, the second intensity, and the intensity of the excitation light; and

connecting between each of the optical output means and each of the optical amplification means, based on the radiation efficiency and the excitation efficiency.

### Advantageous Effects of Invention

The present invention is able to provide an optical amplification system, an optical amplification method, and a storage medium that are capable of reducing power consumption.

### BRIEF DESCRIPTION OF DRAWINGS

FIG. 1 is a block diagram illustrating a configuration example of an optical amplification system according to a first example embodiment of the present invention.

FIG. 2 is a flowchart illustrating an operation of the optical amplification system according to the first example embodiment of the present invention.

FIG. 3 is a flowchart illustrating an operation of a modified example of the optical amplification system according to the first example embodiment of the present invention.

FIG. 4 is a diagram for describing the modified example of the optical amplification system according to the first example embodiment of the present invention.

FIG. 5 is a block diagram illustrating a configuration example of an optical amplification system according to a second example embodiment of the present invention.

FIG. 6 is a flowchart illustrating an operation of the optical amplification system according to the second example embodiment of the present invention.

FIG. 7 is a diagram for describing a modified example of the optical amplification system according to the second example embodiment of the present invention.

FIG. 8 is a flowchart illustrating an operation of the modified example of the optical amplification system according to the second example embodiment of the present invention.

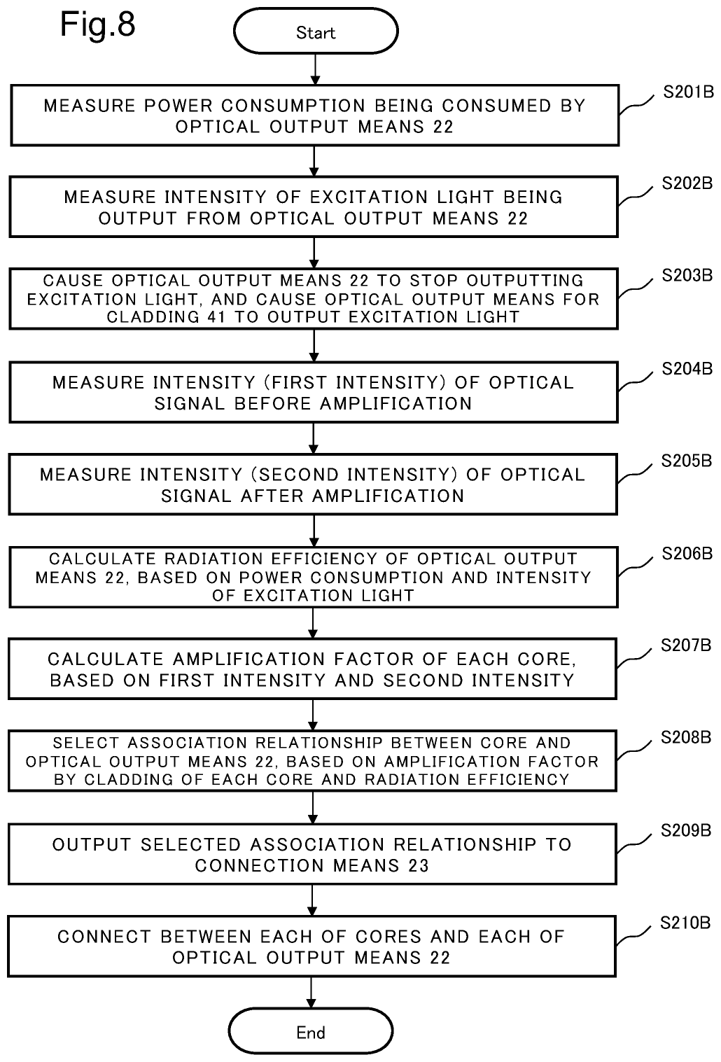

FIG. 9 is a block diagram illustrating a configuration example of an optical amplification system according to a third example embodiment of the present invention.

FIG. 10 is a block diagram illustrating a configuration example of an optical amplification system according to a fourth example embodiment of the present invention.

FIG. 11 is a diagram for describing the optical amplification system according to the fourth example embodiment of the present invention.

FIG. 12 is a flowchart illustrating an operation of the optical amplification system according to the fourth example embodiment of the present invention.

FIG. 13 is a block diagram illustrating a configuration example of an optical communication system according to a fifth example embodiment of the present invention.

FIG. 14 is a block diagram illustrating a configuration example of an optical amplification system according to a sixth example embodiment of the present invention.

FIG. 15 is a flowchart illustrating an operation of the optical amplification system according to the sixth example embodiment of the present invention.

### EXAMPLE EMBODIMENT

### First Example Embodiment

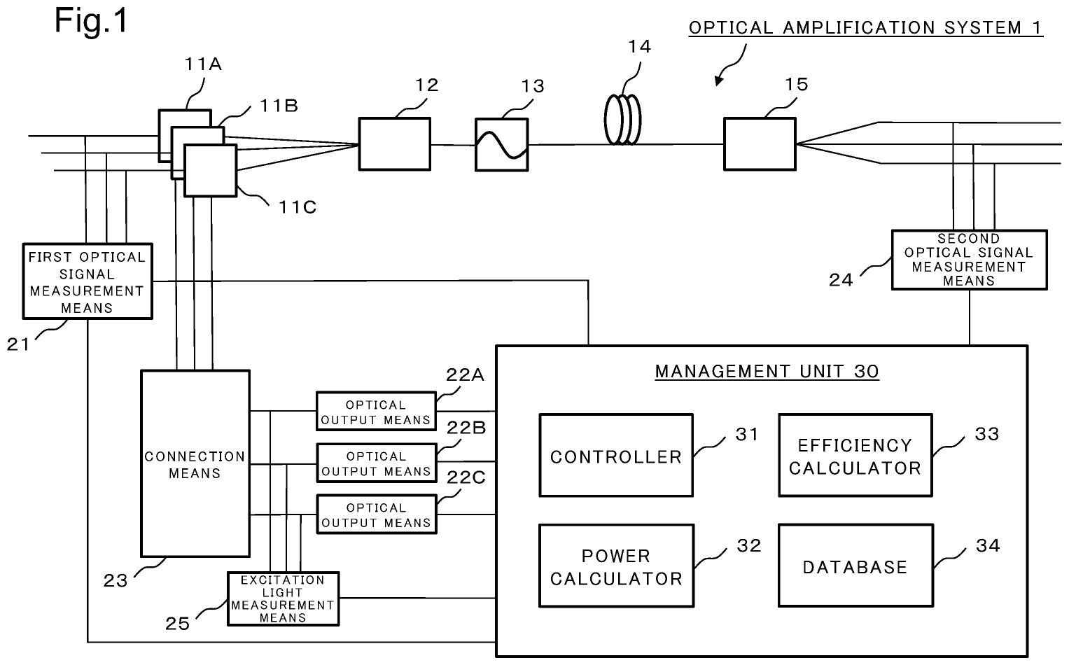

An optical amplification system 1 according to a first example embodiment is described based on FIG. 1. FIG. 1 is a block diagram illustrating a configuration example of the optical amplification system 1. As illustrated in FIG. 1, the optical amplification system 1 includes multiplexing means 11A, 11B, and 11C, a bundle fiber 12, a demultiplexer 13, a multicore erbium doped fiber (EDF) 14, and a bundle fiber 15. The components are connected to one another via an optical fiber.

When it is not necessary to distinguish between the multiplexing means 11A, 11B, and 11C, each of the multiplexing means 11A, 11B, and 11C is referred to as a multiplexing means 11 in the following description. To the multiplexing means 11, excitation light being input from a connection means 23 to be described later and an optical signal from another optical communication device are input. Further, the multiplexing means 11 combines and outputs, to the bundle fiber 12, the optical signal with the excitation light. The multiplexing means 11 is, for example, an optical coupler.

The bundle fiber 12 outputs, to one multicore optical fiber, combined light of excitation light and an optical signal output from the plurality of multiplexing means 11. At this time, the bundle fiber 12 outputs combined light of excitation light and an optical signal to a core (not illustrated) different for each multiplexing means 11. Note that, the above-described core indicates a core included in the multicore optical fiber. For example, when there are the multiplexing means 11A, 11B, and 11C as illustrated in FIG. 1, combined light output from the multiplexing means 11A, combined light output from the multiplexing means 11B, and combined light output from the multiplexing means 11C are output toward cores mutually different for each of the multiplexing means 11A, 11B, and 11C.

The demultiplexer 13 is, for example, an isolator. The demultiplexer 13 prevents light generated inside and outside the optical amplification system 1 from being input from the bundle fiber 15 side to the bundle fiber 12 side. Further, the demultiplexer 13 may be a wavelength filter. In this case, the demultiplexer 13 can prevent light (for example, light other than an optical signal and excitation light) having a wavelength other than a wavelength set in advance as a transmission band from being input to the multicore EDF 14.

The multicore EDF 14 is an optical fiber including a plurality of cores. In each core within the multicore EDF 14, an optical signal is amplified according to excitation light combined with the optical signal. The multicore EDF 14 outputs the optical signal amplified within each core to the bundle fiber 15. Note that, a core included in the multicore EDF 14 is equivalent to an optical amplification means. Further, the multicore EDF 14 is equivalent to a plurality of optical amplification means.

The bundle fiber 15 outputs a plurality of optical signals from the multicore EDF 14 to mutually different optical fibers.

Further, the optical amplification system 1 further includes a first optical signal measurement means 21, optical output means 22A, 22B, and 22C, the connection means 23, a second optical signal measurement means 24, and an excitation light measurement means 25.

The first optical signal measurement means 21 is connected to each of the multiplexing means 11A, 11B, and 11C and a management unit 30 to be described later. The first optical signal measurement means 21 measures intensity of an optical signal before amplification by the multicore EDF 14. Note that, intensity of an optical signal before amplification by the multicore EDF 14 is equivalent to first intensity to be described later. The first optical signal measurement means 21 receives an optical signal branched by a not-illustrated optical branching unit provided in an optical fiber in a preceding stage of the multiplexing means 11. The first optical signal measurement means 21 measures intensity of an optical signal before amplification by the multicore EDF 14, based on intensity of the received optical signal. For example, when a plurality of optical fibers are connected to the multiplexing means 11 as illustrated in FIG. 1, the first optical signal measurement means 21 measures intensity of an optical signal for each optical fiber. The first optical signal measurement means 21 outputs the measured intensity of the optical signal to the management unit 30 to be described later.

When it is not necessary to distinguish between the optical output means 22A, 22B, and 22C, each of the optical output means 22A, 22B, and 22C is referred to as an optical output means 22 in the following description. The optical output means 22 is, for example, a laser diode. A plurality of optical output means 22 are connected to the connection means 23, the excitation light measurement means 25, and the management unit 30. The plurality of optical output means 22 output a plurality of beams of excitation light. The excitation light output from the optical output means 22 is input to each of the multiplexing means 11 via the connection means 23.

The connection means 23 connects between each of the plurality of optical output means 22 and each of the multicore EDFs 14 via each of the plurality of multiplexing means 11, the bundle fiber 12, and the demultiplexer 13. Specifically, the connection means 23, the multiplexing means 11, the bundle fiber 12, and the demultiplexer 13 connect between each of the plurality of optical output means 22 and each of the multicore EDFs 14. Since the core within the multicore EDF 14 to which each multiplexing means 11 is connected is fixed, the connection means 23 can switch a connection relationship between the core within the multicore EDF 14 and the optical output means 22 by switching a connection relationship between each multiplexing means 11 and each optical output means 22. For example, the connection means 23 can switch a connection destination of the optical output means 22A from one core to another core within the multicore EDF 14. The connection means 23 is, for example, a matrix switch.

The second optical signal measurement means 24 is connected to the bundle fiber 15 and the management unit 30. The second optical signal measurement means 24 measures intensity of an optical signal after amplification by the multicore EDF 14. Note that, intensity of an optical signal after amplification by the multicore EDF 14 is equivalent to second intensity to be described later. The second optical signal measurement means 24 receives an optical signal branched by a not-illustrated optical branching unit provided in an optical fiber in a subsequent stage of the bundle fiber 15. The second optical signal measurement means 24 measures intensity of an optical signal after amplification by the multicore EDF 14, based on intensity of the received optical signal. For example, when a plurality of optical fibers are connected to the bundle fiber 15 as illustrated in FIG. 1, the second optical signal measurement means 24 measures intensity of an optical signal for each optical fiber. The second optical signal measurement means 24 outputs the measured intensity of the optical signal to the management unit 30 to be described later.

The excitation light measurement means 25 is connected to the connection means 23, each of the plurality of optical output means 22, and the management unit 30. The excitation light measurement means 25 measures intensity of excitation light output from each of the plurality of optical output means 22. The excitation light measurement means 25 receives excitation light branched by a not-illustrated optical branching unit provided in an optical fiber between the optical output means 22 and the optical output means 22. The excitation light measurement means 25 measures intensity of excitation light output from the optical output means 22, based on intensity of the received excitation light. For example, when the plurality of optical output means 22 are provided as illustrated in FIG. 1, the excitation light measurement means 25 measures intensity of excitation light for each optical output means 22. The excitation light measurement means 25 outputs the measured intensity of the excitation light to the management unit 30 to be described later.

The optical amplification system 1 further includes the management unit 30. The management unit 30 includes a controller 31, a power calculator 32, an efficiency calculator 33, and a database 34.

The controller 31 instructs the connection means 23 on a connection relationship between the plurality of optical output means 22 and the plurality of cores within the multicore EDF 14. The connection means 23 connects between the optical output means 22 and the multiplexing means 11 being connected to the core within the multicore EDF, according to an instruction from the controller. The above-described connection relationship indicates a combination of the optical output means 22 and the core within the multicore EDF 14 to be connected to each other.

The power calculator 32 measures power consumption being consumed by each of the plurality of optical output means 22. The power calculator 32 is equivalent to a power consumption measurement means. The above-described optical output means 22 outputs excitation light having intensity according to magnitude of input electric power. The power calculator 32 calculates electric power being input to each optical output means 22 as a power consumption. The power calculator 32 may measure electric current being input to the optical output means 22 or voltage being applied to the optical output means 22, instead of electric power.

The efficiency calculator 33 calculates a radiation efficiency of the optical output means 22, based on a power consumption being consumed by the optical output means 22 and intensity of excitation light being output from the optical output means 22. The efficiency calculator 33 is equivalent to a first calculation means. For example, the efficiency calculator 33 calculates a ratio of intensity of excitation light to power consumption as a radiation efficiency. The optical output means 22 having a high radiation efficiency can output excitation light having greater intensity with less power consumption.

The efficiency calculator 33 calculates an excitation efficiency of the multicore EDF 14, based on first intensity, second intensity, and intensity of excitation light. The efficiency calculator 33 is equivalent to a second calculation means. The efficiency calculator 33 acquires, from the first optical signal measurement means 21, intensity (first intensity) of an optical signal before amplification by the multicore EDF 14. Further, the efficiency calculator 33 acquires, from the second optical signal measurement means 24, intensity (second intensity) of an optical signal after amplification by the multicore EDF 14. The efficiency calculator 33 calculates a ratio of the second intensity to the first intensity as an amplification factor of the core. The efficiency calculator 33 calculates an amplification factor of each of the plurality of cores.

Further, the efficiency calculator 33 further acquires, from the excitation light measurement means 25, intensity of excitation light output from each of the plurality of optical output means 22. The efficiency calculator 33 calculates a ratio of an amplification factor of the core to intensity of excitation light being input to the core, as an excitation efficiency of the core.

Note that, the efficiency calculator 33 may calculate a ratio of an amplification factor of the core to a power consumption of the optical output means 22 that outputs excitation light to be input to the core, as an excitation efficiency of the core. At this time, the controller 31 causes excitation light from one optical output means 22 to be sequentially output to different cores. The efficiency calculator 33 acquires intensity (first intensity) of an optical signal before amplification by the core to which the excitation light is input and intensity (second intensity) of an optical signal after amplification by the core to which the excitation light is input. The efficiency calculator 33 further acquires a power consumption being consumed by the optical output means 22. The efficiency calculator 33 calculates a ratio of the second intensity to the first intensity as an amplification factor of the core. The efficiency calculator 33 further calculates a ratio of the amplification factor of the core to the power consumption of the optical output means 22, as an excitation efficiency of the core.

The controller 31 acquires, from the efficiency calculator 33, a radiation efficiency of each optical output means 22 and an excitation efficiency of each core within the multicore EDF 14. The controller 31 associates the core having the low excitation efficiency with each of the plurality of optical output means 22 in descending order of the radiation efficiency. For example, the controller 31 associates the core having the lowest excitation efficiency with the optical output means 22 having the highest radiation efficiency. Further, the controller 31 associates the core having the second lowest excitation efficiency with the optical output means 22 having the second highest radiation efficiency. The controller 31 outputs an association relationship between the core and the optical output means 22 to the connection means 23. The connection means 23 connects between the optical output means 22 and the core according to the input association relationship. Further, the controller 31 is provided communicably with the components within the optical amplification system 1.

The database 34 acquires, from the efficiency calculator 33, a radiation efficiency of each optical output means 22 and an excitation efficiency of each core within the multicore EDF 14. Further, the database 34 may acquire and store an association relationship between the optical output means 22 and the core from the controller 31. Further, the database 34 may store other pieces of information.

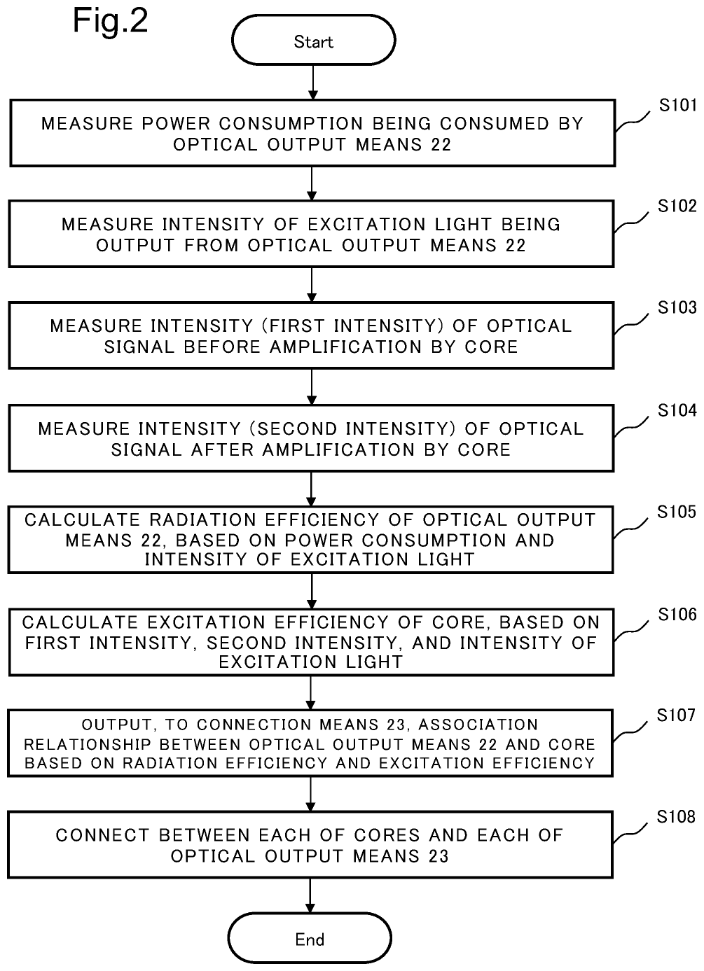

Next, an operation of the optical amplification system 1 is described by using FIG. 2. FIG. 2 is a flowchart illustrating an operation of the optical amplification system 1.

The power calculator 32 measures a power consumption being consumed by the optical output means 22 (S101). The excitation light measurement means 25 measures intensity of excitation light being output from the optical output means 22 (S102). The first optical signal measurement means 21 measures intensity (first intensity) of an optical signal before amplification by the core (S103). The second optical signal measurement means 24 measures intensity of an optical signal after amplification by the multicore EDF 14 (S104). Note that, order of the processing of S101 to S104 may be switched, or the processing of S101 to S104 may be performed in parallel.

The efficiency calculator 33 calculates a radiation efficiency of the optical output means 22, based on the power consumption and the intensity of the excitation light (S105). Further, the efficiency calculator 33 calculates an excitation efficiency of the core, based on the first intensity, the second intensity, and the intensity of the excitation light (S106). Note that, order of the processing of S105 and S106 may be switched, or the processing of S105 and S106 may be performed in parallel.

The controller 31 outputs, to the connection means 23, an association relationship between the optical output means 22 and the core based on the radiation efficiency and the excitation efficiency (S107). Further, the connection means 23 connects between each of the cores and each of the optical output means 22 (S108). Note that, after the processing of S107, the management unit 30 may adjust electric power to be supplied to the optical output means 22 in such a way that the second intensity being measured by the second optical signal measurement means 24 becomes a predetermined target value.

As described above, the optical amplification system 1 includes the plurality of optical output means 22, the plurality of cores (the plurality of multicore EDFs 14), the power calculator 32, the excitation light measurement means 25, the first optical signal measurement means 21, the second optical signal measurement means 24, the efficiency calculator 33, and the connection means 23. The plurality of cores are equivalent to the plurality of multicore EDFs 14. The power calculator 32 is equivalent to the power consumption measurement means. Further, the efficiency calculator 33 is equivalent to the first calculation means and the second calculation means. Further, the plurality of optical output means 22 output excitation light. The plurality of cores amplify an optical signal according to the excitation light. The power calculator 32 measures power consumption being consumed by each of the plurality of optical output means 22. The first optical signal measurement means 21 measures first intensity of an optical signal before amplification by the core. The second optical signal measurement means 24 measures second intensity of an optical signal after amplification by the core. The efficiency calculator 33 calculates a radiation efficiency of the optical output means 22, based on the power consumption of the optical output means 22 and intensity of the excitation light. Further, the efficiency calculator 33 calculates an excitation efficiency of the core, based on the above-described first intensity, the above-described second intensity, and the intensity of the excitation light. Further, the connection means 23 connects between each of the optical output means 22 and each of the cores, based on the radiation efficiency and the excitation efficiency.

In a general optical communication system, it is necessary to amplify all optical signals to equal to or more than predetermined intensity. Thus, when a core having a low excitation efficiency is connected to an optical output means having a low radiation efficiency, it is necessary to supply significantly large electric power to the optical output means in order to amplify an optical signal propagating through the core to predetermined intensity. Meanwhile, in the optical amplification system 1, the connection means 23 connects between each of the plurality of optical output means 22 and each of the plurality of cores, based on the radiation efficiency and the excitation efficiency. Thereby, the optical amplification system 1 can connect, for example, between one having a high radiation efficiency among the plurality of optical output means 22 and a core having a low excitation efficiency, and can connect between one having a low radiation efficiency among the plurality of optical output means 22 and a core having a high excitation efficiency. As a result, the optical amplification system 1 can reduce power consumption, since it is not necessary to supply significantly large electric power to one optical output means 22.

Next, an optical amplification system 1A is described. The optical amplification system 1A is a modified example of the optical amplification system 1. The optical amplification system 1A includes a configuration similar to the optical amplification system 1 illustrated in FIG. 1.

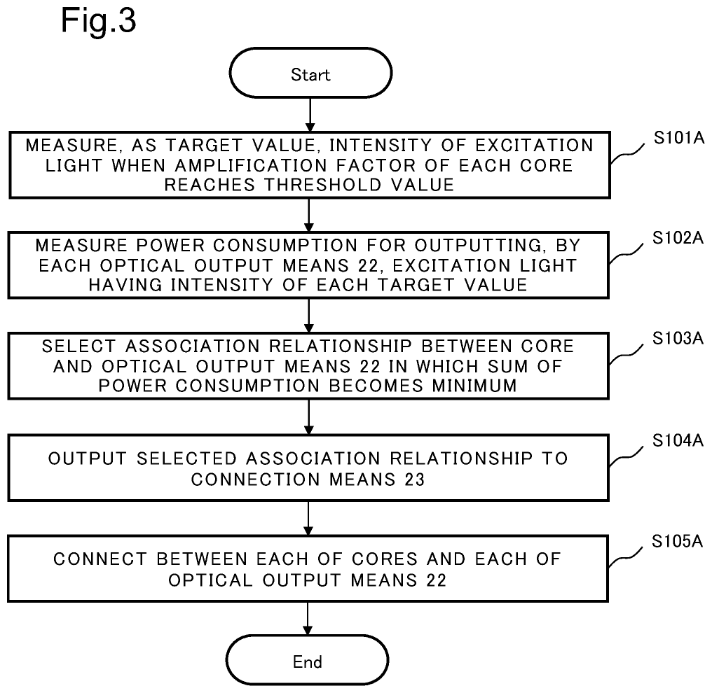

An operation of the optical amplification system 1 is described by using FIG. 3. FIG. 3 is a flowchart illustrating an operation of the optical amplification system 1.

The excitation light measurement means 25 measures, as a target value, intensity of excitation light when an amplification factor of each core reaches a target value (S101A). Specifically, the controller 31 adjusts a power consumption to be supplied to the optical output means 22, while the efficiency calculator 33 calculates an amplification factor of a core to which the optical output means 22 supplies excitation light. The controller 31 acquires, from the excitation light measurement means 25, intensity of excitation light at a point of time when the amplification factor reaches a threshold value. For example, the controller 31 acquires that intensity of excitation light when an amplification factor of a first core among a plurality of cores reaches a target value is 0.39 W. When there are four cores, the controller 31 further acquires that intensity of excitation light when a second core, a third core, and a fourth core reach a target value is 0.41 W, 0.42 W, and 0.53 W, respectively.

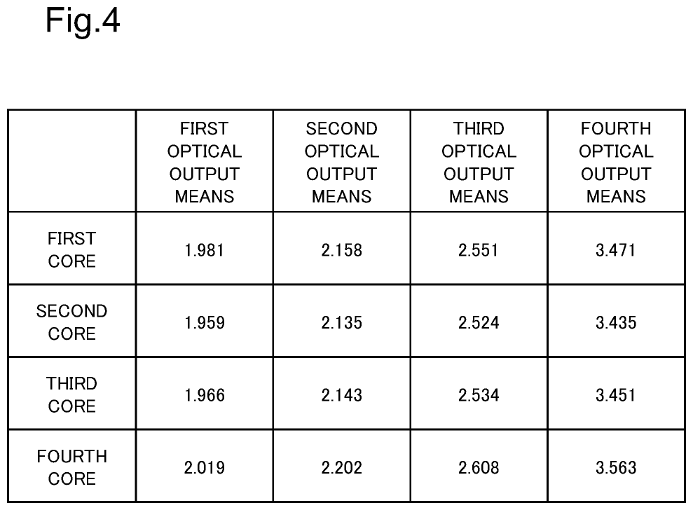

The power calculator 32 measures a power consumption for outputting, by each optical output means 22, excitation light having intensity of each target value (S102A). Specifically, the power calculator 32 measures electric power to be consumed by the optical output means 22 in order to output excitation light having intensity necessary for an amplification factor of each core to reach a target value, as illustrated in FIG. 4. FIG. 4 is a diagram illustrating an association relationship between each core and the optical output means 22 when the multicore EDF 14 has four cores and the optical amplification system 1 has four optical output means 22. FIG. 4 indicates, for example, that a power consumption necessary for a fourth core is 2.019 W in order to achieve a target value of an amplification factor of the fourth core.

The controller 31 selects an association relationship between a core and the optical output means 22 in which a sum of power consumption becomes minimum (S103A). For example, in an example in FIG. 4, a sum total of power consumption becomes minimum when a first optical output means 221 is associated with the fourth core, a second optical output means 222 is associated with a first core, a third optical output means 223 is associated with a third core, and a fourth optical output means 224 is associated with a second core.

The controller 31 outputs the selected association relationship to the connection means 23 (S104A). Further, the connection means 23 connects between each of the cores and each of the optical output means 22 according to the output association relationship (S105A). In the above example, the connection means 23 connects between the first optical output means 221 and the fourth core, connects between the second optical output means 222 and the first core, connects between the third optical output means 223 and the third core, and connects between the fourth optical output means 224 and the second core.

### Second Example Embodiment

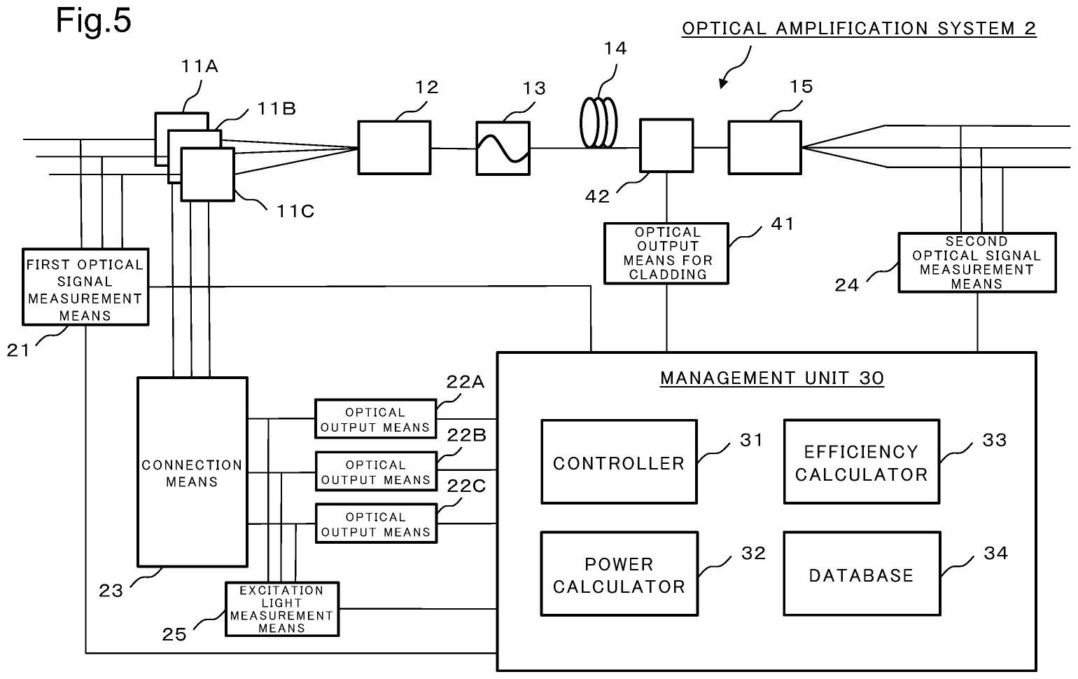

An optical amplification system 2 according to a second example embodiment is described based on FIG. 5. FIG. 5 is a block diagram illustrating a configuration example of the optical amplification system 2. As illustrated in FIG. 5, the optical amplification system 2 includes multiplexing means 11A, 11B, and 11C, a bundle fiber 12, a demultiplexer 13, a multicore erbium doped fiber (EDF) 14, and a bundle fiber 15, similarly to the optical amplification system 1. The optical amplification system 2 further includes an optical output means for cladding 41 and a multiplexer 42.

The optical output means for cladding 41 outputs excitation light to be input to cladding of the multicore EDF 14. The multiplexer 42 inputs the excitation light from the optical output means for cladding 41 to an optical fiber between the multicore EDF 14 and the bundle fiber 15. Thereby, the excitation light from the optical output means for cladding 41 is input to the cladding of the multicore EDF 14.

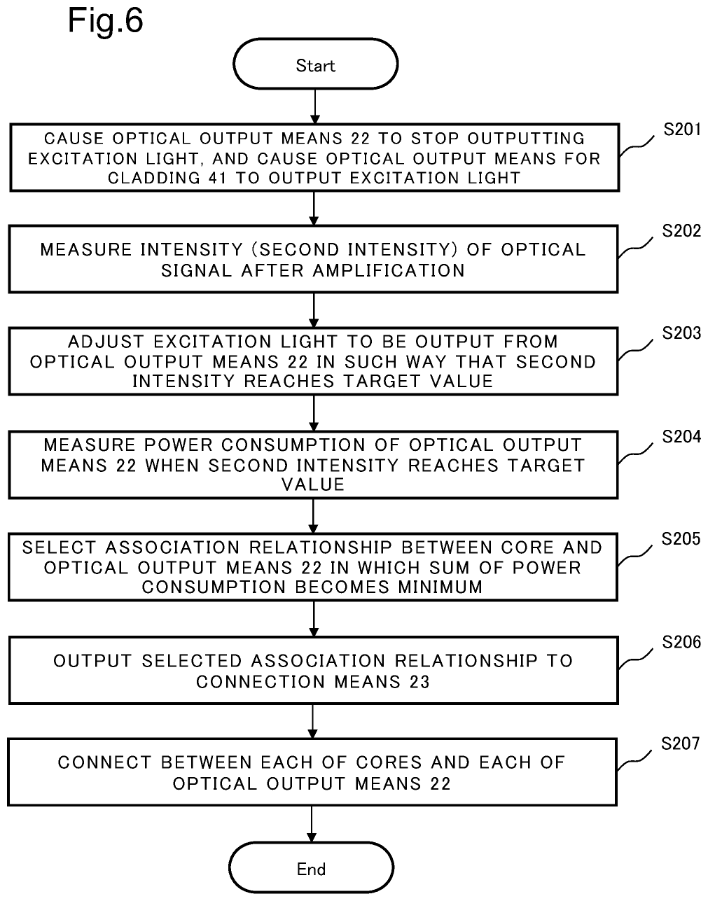

Next, an operation of the optical amplification system 2 is described by using FIG. 6. FIG. 6 is a flowchart illustrating an operation of the optical amplification system 2. A controller 31 issues an instruction to an optical output means 22 and the optical output means for cladding 41, causes the optical output means 22 to stop outputting excitation light, and causes the optical output means for cladding 41 to output excitation light (S201). Thereby, the multicore EDF 14 amplifies an optical signal propagating through each core by means of only the cladding.

The second optical signal measurement means 24 measures intensity (second intensity) of an optical signal after amplification (S202). For example, when there are four cores, the second optical signal measurement means 24 measures that intensity of an optical signal amplified by a first core is 19.03 dBm, intensity of an optical signal amplified by a second core is 18.7 dBm, intensity of an optical signal amplified by a third core is 18.37 dBm, and intensity of an optical signal amplified by a fourth core is 17.95 dBm.

The controller 31 adjusts excitation light to be output from each optical output means 22 in such a way that the second intensity reaches a target value (S203). In the above-described example, the second optical signal measurement means 24 adjusts electric power to be supplied to each optical output means 22 in such a way that the intensity (second intensity) of the optical signals after amplification by all of the cores becomes 19.03 dBm. Note that, the second optical signal measurement means 24 may set a value exceeding 19.03 dBm (the intensity of the optical signal amplified by the first core) as a target value, and may adjust electric power to be supplied to each optical output means 22 in such a way that the intensity (second intensity) of the optical signals after amplification by all of the cores becomes the target value.

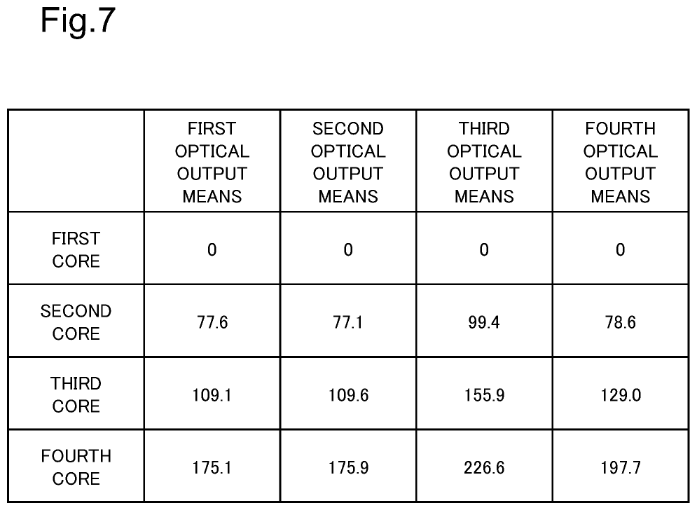

The power calculator 32 measures a power consumption of the optical output means 22 when the second intensity reaches the target value. FIG. 7 illustrates power consumption measured by the power calculator 32. For example, FIG. 7 indicates that, when excitation light from a first optical output means is input to the second core in the above-described example, it is necessary to supply a power consumption of 77.6 mw to the first optical output means in order that the intensity of the optical signal after amplification by the second core matches the target value.

The controller 31 selects an association relationship between a core and the optical output means 22 in which a sum of power consumption becomes minimum. In an example illustrated in FIG. 7, a sum total of power consumption becomes minimum when a first optical output means 22 is associated with the fourth core, a second optical output means 22 is associated with the third core, a third optical output means 22 is associated with the first core, and a fourth optical output means 22 is associated with the second core.

The controller 31 outputs the selected association relationship to the connection means 23 (S206). The connection means 23 connects between each of the cores and each of the optical output means 22 according to the input association relationship. In the above example, the connection means 23 connects between the first optical output means 22 and the fourth core, connects between the second optical output means 22 and the third core, connects between the third optical output means 22 and the first core, and connects between the fourth optical output means 22 and the second core (S207).

Next, an optical amplification system 2A is described. The optical amplification system 2A is a modified example of the optical amplification system 2. The optical amplification system 2A includes a configuration similar to the optical amplification system 2 illustrated in FIG. 5. Further, an operation of the optical amplification system 2A is similar to the operation of the optical amplification system 1. Specifically, the optical amplification system 2A operates according to the flowchart illustrated in FIG. 2.

Next, an optical amplification system 2B is described. The optical amplification system 2B is a modified example of the optical amplification system 2. The optical amplification system 2A includes a configuration similar to the optical amplification system 2 illustrated in FIG. 5.

An operation of the optical amplification system 2B is described. The power calculator 32 measures a power consumption being consumed by the optical output means 22 (S201B). The excitation light measurement means 25 measures intensity of excitation light being output from the optical output means 22 (S202B). The controller 31 issues an instruction to the optical output means 22 and the optical output means for cladding 41, causes the optical output means 22 to stop outputting excitation light, and causes the optical output means for cladding 41 to output excitation light (S203B). The first optical signal measurement means 21 measures intensity (first intensity) of an optical signal before amplification by the core (S204B). The second optical signal measurement means 24 measures intensity of an optical signal after amplification by the multicore EDF 14 (S205B). Note that, order of the processing of S201B and S202B may be switched, or the processing of S201B and S202B may be performed in parallel. Further, order of the processing of S204B and S205B may be switched, or the processing of S204B and S205B may be performed in parallel.

The efficiency calculator 33 calculates a radiation efficiency of the optical output means 22, based on the power consumption and the intensity of the excitation light (S206B). Further, the efficiency calculator 33 calculates an amplification factor of the core, based on the first intensity and the second intensity (S207B). Note that, order of the processing of S206B and S207B may be switched, or the processing of S206B and S207B may be performed in parallel.

The controller 31 selects an association relationship between the core and the optical output means 22, based on the amplification factor by the cladding of each core and the radiation efficiency (S208B). Specifically, the controller 31 associates the core having the low amplification factor by the cladding with each of the plurality of optical output means 22 in descending order of the radiation efficiency. For example, the controller 31 associates the core having the lowest amplification factor with the optical output means 22 having the highest radiation efficiency. Further, the controller 31 associates the core having the second lowest amplification factor with the optical output means 22 having the second highest radiation efficiency. The controller 31 outputs the association relationship between the core and the optical output means 22 to the connection means 23 (S209B). The connection means 23 connects between the optical output means 22 and the core according to the input association relationship (S210B).

### Third Example Embodiment

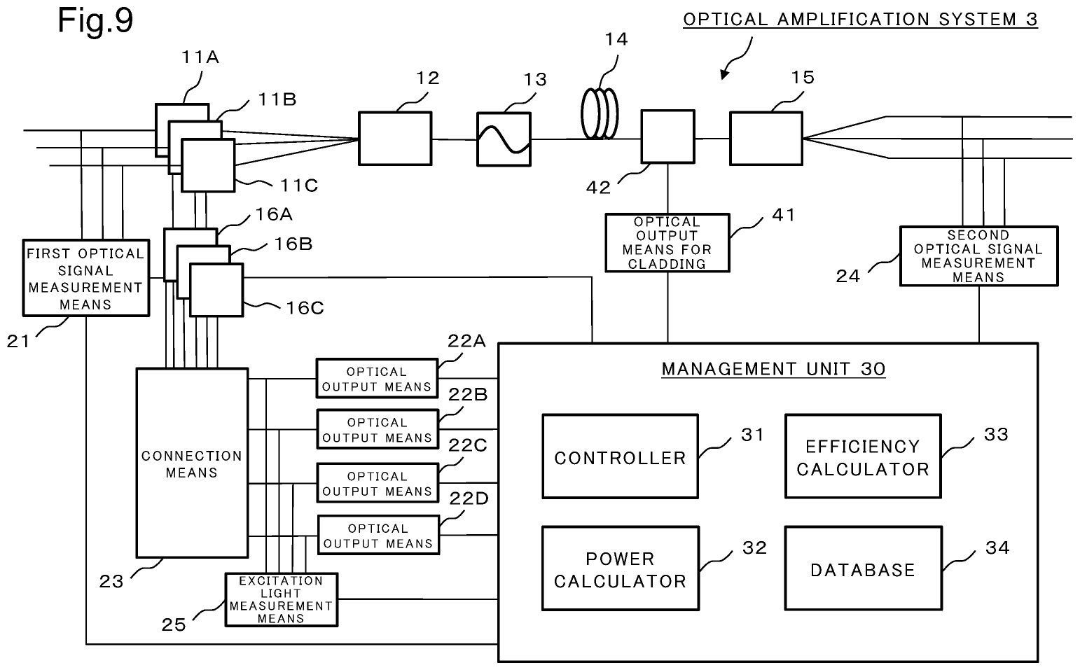

An optical amplification system 3 according to a third example embodiment is described based on FIG. 9. FIG. 9 is a block diagram illustrating a configuration example of the optical amplification system 3. As illustrated in FIG. 5, the optical amplification system 2 includes multiplexing means 11A, 11B, and 11C, a bundle fiber 12, a demultiplexer 13, a multicore erbium doped fiber (EDF) 14, a bundle fiber 15, an optical output means for cladding 41, and a multiplexer 42, similarly to the optical amplification system 1. The optical amplification system 3 includes an additional optical output means 22 and multiplexers 16A, 16B, and 16C.

The additional optical output means 22D is an excitation light source capable of outputting excitation light. It is assumed that the additional optical output means 22D is not connected to any of a plurality of cores (a plurality of multicore EDFs 14). Meanwhile, it is assumed that the optical output means 22A, 22B, and 22C are connected to any of the plurality of cores.

A case is described in which the additional optical output means 22D is connected to any of the plurality of cores, instead of one of the optical output means 22A, 22B, and 22C. For example, it is assumed that the optical output means 22A, 22B, and 22C are respectively connected to a first core, a second core, and a third core within the multicore EDF 14. In this example, when the optical output means 22D is connected to the first core instead of the optical output means 22A, the multiplexer 16 combines and outputs, to the core, excitation light being output from the optical output means 22A with excitation light being output from the optical output means 22D. At this time, the optical output means 22D gradually rises intensity of excitation light being output. Meanwhile, the optical output means 22A gradually decreases intensity of excitation light being output by the own means, and stops outputting the excitation light. Note that, the optical output means 22A and the optical output means 22D are adjusted in such a way that intensity of the combined excitation light becomes same as intensity of the excitation light that has been output by the optical output means 22A to the first core.

Thereby, since excitation light can be supplied from a new optical output means 22 to the core, for example, an association relationship between the new optical output means 22 and the core can be calculated in S107 of the operation of the optical amplification system 1. Similarly, an association relationship between the new optical output means 22 and the core can be calculated also in S103A of the optical amplification system 1A, S206 of the optical amplification system 2, and S208B of the optical amplification system 2B. Thus, the third example embodiment can reduce power consumption by also considering the new optical output means 22 other than the optical output means 22 already outputting excitation light.

### Fourth Example Embodiment

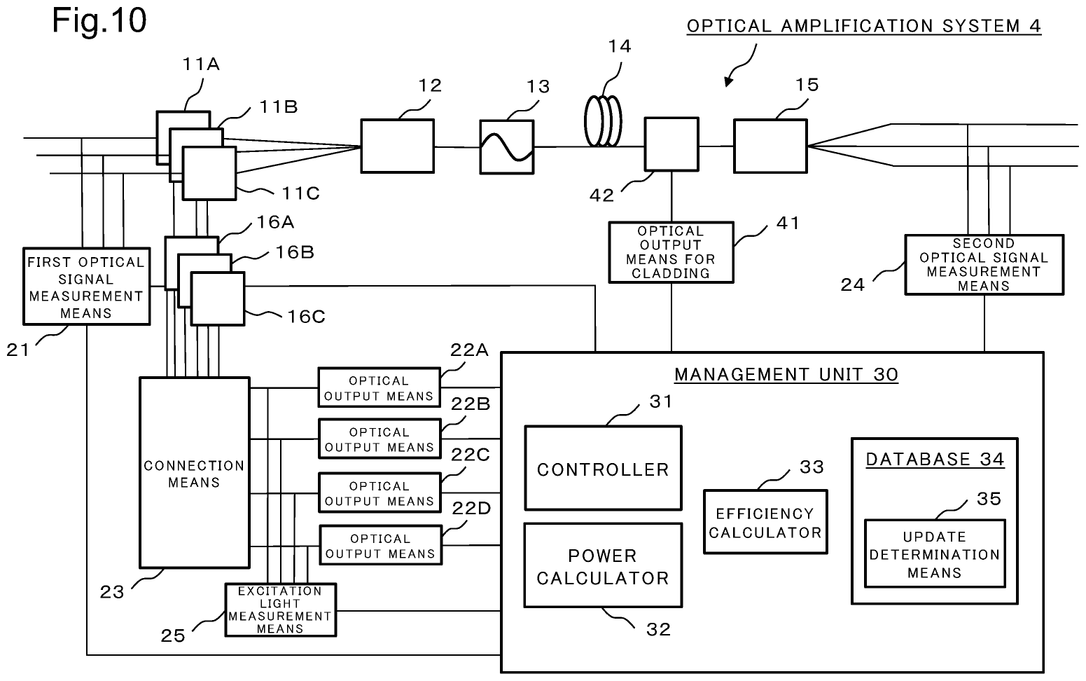

An optical amplification system 4 according to a fourth example embodiment is described based on FIG. 10. FIG. 10 is a block diagram illustrating a configuration example of the optical amplification system 4. As illustrated in FIG. 10, the optical amplification system 4 includes multiplexing means 11A, 11B, and 11C, a bundle fiber 12, a demultiplexer 13, a multicore erbium doped fiber (EDF) 14, a bundle fiber 15, an optical output means for cladding 41, a multiplexer 42, an additional optical output means 22, and multiplexers 16A, 16B, and 16C, similarly to the optical amplification system 3. The optical amplification system 4 is different from the optical amplification system 3 in a point of further including an update determination means 35 within a database 34.

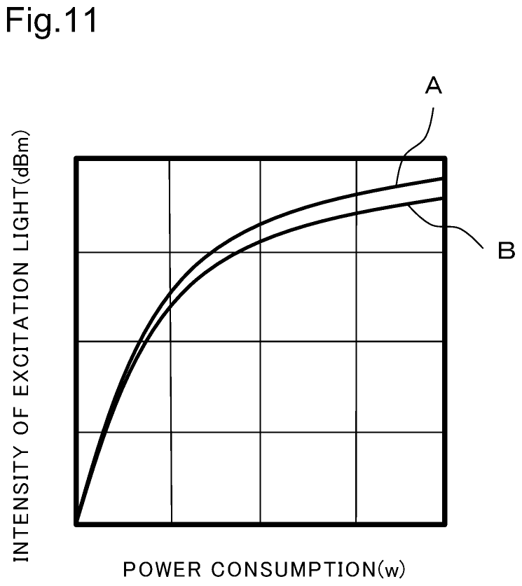

The database 34 in the optical amplification system 4 includes a graph indicating a correlation between a power consumption of each optical output means 22 and intensity of excitation light being output from each optical output means 22. For example, the database 34 includes a graph A illustrated in FIG. 11. FIG. 11 is a graph illustrating a correlation between a power consumption of the optical output means 22 and intensity of excitation light.

The update determination means 35 monitors a power consumption of the optical output means 22 and intensity of excitation light, and outputs a notification including an amount of change in the power consumption to the database 34. Further, when the amount of change in the power consumption exceeds a predetermined threshold value, the update determination means 35 issues an instruction to the database 34 to update a correlation between the power consumption and the intensity of excitation light.

Specifically, the update determination means 35 acquires, for example, that a power consumption of the optical output means 22 is 110 mw and intensity of excitation light is 10 dBm. At this time, the update determination means 35 refers to the graph in FIG. 11 stored in the database 34, and acquires a power consumption associated with intensity (10 dbm) of excitation light. The update determination means 35 acquires, from the database 34, for example, that a power consumption associated with intensity (10 dBm) of excitation light is 110 mw. At this time, the update determination means 35 outputs, to the database 34, a notification including that an amount of change in the power consumption is 10%, to the database 34. Furthermore, when including that a threshold value for the amount of change is 5%, the update determination means 35 issues an instruction to update a correlation between the power consumption and the intensity of excitation light, since the amount of change in the power consumption exceeds the threshold value.

The database 34 updates a correlation between a power consumption and intensity of excitation light, based on a change in the power consumption notified by the update determination means 35. Specifically, when an amount of change in the power consumption is 10%, the database 34 adds a 10% increase to a value of the power consumption in a correlation within the database 34. For example, a 10% increase is added to the power consumption in the graph A in FIG. 11, thereby updating the graph A to a graph B.

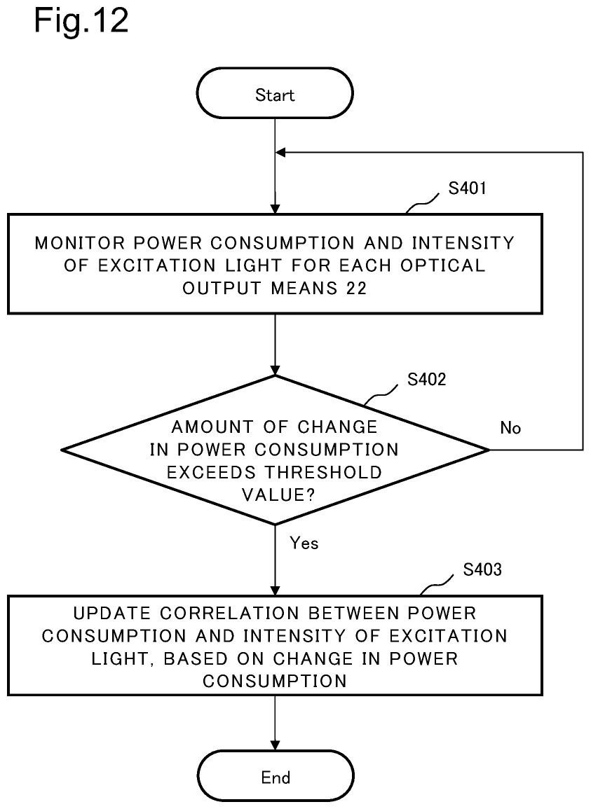

Next, an operation example of the optical amplification system 4 is described by using FIG. 12.

The update determination means 35 monitors a power consumption and intensity of excitation light for each optical output means 22 (S401). The update determination means 35 determines whether an amount of change in the power consumption exceeds a threshold value (S402). When the amount of change in the power consumption does not exceed the threshold value (No in S402), the update determination means 35 repeats the processing of S401. Meanwhile, when the amount of change in the power consumption exceeds the threshold value (Yes in S402), the database 34 updates a correlation between the power consumption and the intensity of excitation light, based on a change in the power consumption (S403). Note that, the above-described processing of S401 to S403 may be executed in parallel with the above-described operation of the optical amplification system 1, 1A, 2, 2A, 2B, or 3.

Next, an optical amplification system 4A is described. The optical amplification system 4A is a modified example of the optical amplification system 4. The optical amplification system 4A includes a configuration similar to the optical amplification system 4 illustrated in FIG. 10. Further, an operation of the optical amplification system 4 is similar to the operation of the optical amplification system 3. The optical amplification system 4A performs a following operation, in addition to the operation of the optical amplification system 3.

In the description of the optical amplification system 3, a case of disconnecting between the optical output means 22A and the core and connecting the additional optical output means 22D to any of a plurality of cores has been described. At this time, the update determination means 35 issues an instruction to the database 34 to update a correlation between the power consumption of the optical output means 22A that has stopped outputting excitation light and the intensity of excitation light, after connecting the additional optical output means 22D to any of a plurality of cores.

The database 34 transfers the instruction from the update determination means 35 to the controller 31. The controller 31 issues an instruction to the optical output means 22A to output excitation light again. Thereby, the optical output means 22A that has stopped outputting excitation light among the plurality of optical output means 22 outputs excitation light again.

The database 34 updates the above-described correlation, based on a power consumption being consumed by the optical output means 22A and intensity of excitation light being output by the optical output means 22A. At this time, as the optical output means 22A sequentially changes the intensity of excitation light, the database 34 can acquire a power consumption according to intensity of excitation light and update a correlation to a new one.

### Fifth Example Embodiment

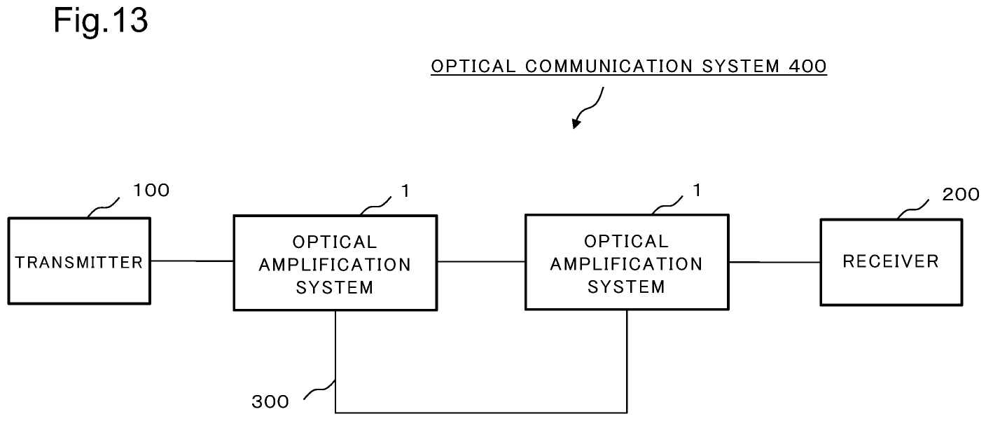

Next, an optical communication system 400 is described by using FIG. 13. FIG. 13 is a schematic diagram of the optical communication system 400 including a plurality of optical amplification systems 1. The optical amplification system 1 includes the configuration illustrated in FIG. 1.

In the optical communication system 400, an optical signal transmitted from a transmitter 100 is relayed by the plurality of optical amplification systems 1 and received by a receiver 200. Note that, while FIG. 13 indicates that two optical amplification systems 1 are provided between the transmitter 100 and the receiver 200, other optical devices (a filter, an optical amplification device, and the like) may be further provided.

A transmission path from the optical amplification system 1 in a preceding stage to the receiver 200 propagates a plurality of optical signals output from a multicore EDF 14 (a plurality of multicore EDFs 14) within the optical amplification system 1 provided on a preceding stage side.

A first optical signal measurement means 21 provided within the optical amplification system 1 in a subsequent stage is provided on the above-described transmission path, and measures intensity of the plurality of optical signals on the transmission path. Note that, the first optical signal measurement means 21 provided within the optical amplification system 1 in the subsequent stage is equivalent to a third optical signal measurement means. Further, intensity measured by the first optical signal measurement means 21 provided within the optical amplification system 1 in the subsequent stage is equivalent to third intensity.

In the optical communication system 400, the two optical amplification systems 1 are connected by a line 300. For example, management units 30 in the two optical amplification systems 1 are communicably connected to each other. The management unit 30 provided within the optical amplification system 1 in the subsequent stage transmits the third intensity measured by the first optical signal measurement means 21 to the management unit 30 provided within the optical amplification system 1 in the preceding stage.

The management unit 30 within the optical amplification system 1 in the preceding stage instructs a connection means 23 to update a connection relationship between each of the optical output means 22 and each of cores within the multicore EDF 14. Specifically, the management unit 30 repeats the processing of S101 to S108 again. Thereby, the connection means 23 updates a connection relationship between each of the optical output means 22 and each of cores (the multicore EDFs 14) within the multicore EDF 14 when the third intensity has changed by equal to or more than a predetermined value.

Note that, when the optical amplification system 1A is provided instead of the optical amplification system 1, the connection means 23 updates a connection relationship between each of the optical output means 22 and each of cores (the multicore EDFs 14) within the multicore EDF 14 by repeating the processing of S101A to 105A. Similarly, in the optical communication system 400, the optical amplification system 2, 2A, 2B, 3, or 4 may be used instead of the optical amplification system 1.

A modified example of the optical output means 22 according to all of the above example embodiments is described. In the above-described description, it is stated that one optical output means 22 is, for example, one laser diode. Meanwhile, the plurality of optical output means 22 may output excitation light to the plurality of cores (the plurality of multicore EDFs 14) within the multicore EDF 14, by branching light being output from one light source. At this time, intensity of excitation light to be input to each core is adjusted by a branching ratio to light from a light source. Further, the optical output means 22 may output excitation light to the core (the multicore EDFs14) within the multicore EDF 14, by combining beams of light being output from a plurality of light sources.

### Sixth Example Embodiment

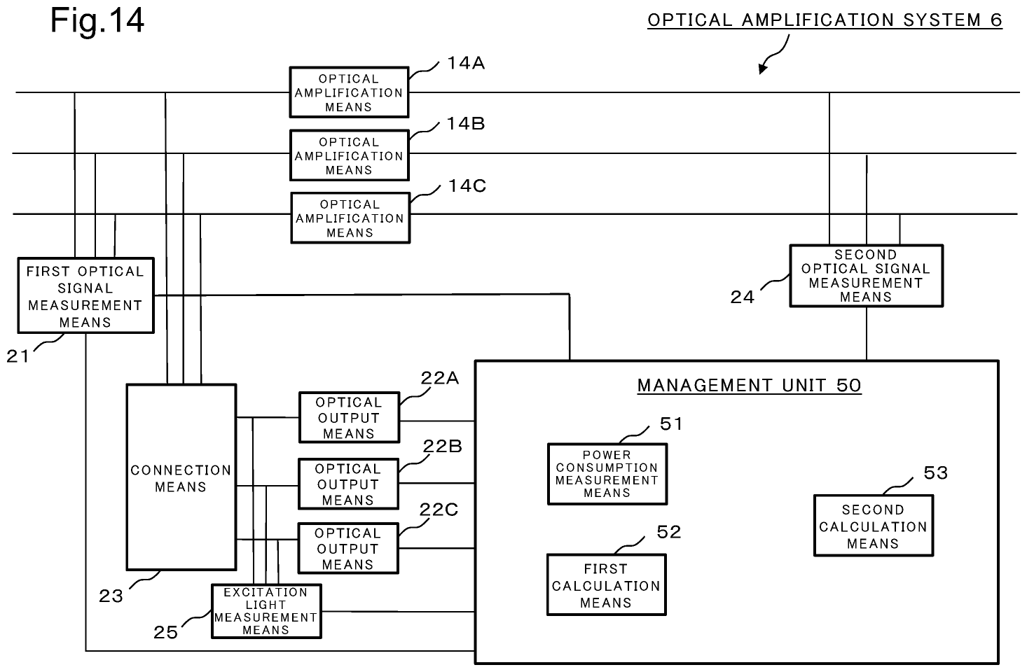

Next, an optical communication system 400 is described by using FIG. 14. FIG. 14 is a schematic diagram of the optical amplification system 6. As illustrated in FIG. 14, the optical amplification system 6 includes a plurality of optical amplification means (multicore EDFs 14A, 14B, and 14C), a first optical signal measurement means 21, optical output means 22A, 22B, and 22C, a connection means 23, a second optical signal measurement means 24, an excitation light measurement means 25, and a management unit 50. The management unit 50 includes a power consumption measurement means 51, a first calculation means 52, and a second calculation means 53. When it is not necessary to distinguish between the optical amplification means (the multicore EDFs 14A, 14B, and 14C), each of the optical amplification means (the multicore EDFs 14A, 14B, and 14C) is referred to as an optical amplification means 14 in the following description. Further, when it is not necessary to distinguish between the optical output means 22A, 22B, and 22C, each of the optical output means 22A, 22B, and 22C is referred to as an optical output means 22 in the following description.

The plurality of optical output means 22 output excitation light. The plurality of multicore EDFs 14 amplify an optical signal according to the excitation light. The power consumption measurement means 51 measures power consumption being consumed by each of the plurality of optical output means 22.

The excitation light measurement means 25 measures intensity of excitation light output from each of the plurality of optical output means 22. The first optical signal measurement means 21 measures first intensity of an optical signal before amplification by the multicore EDF 14. The second optical signal measurement means 24 measures second intensity of an optical signal after amplification by the multicore EDF 14.

The first calculation means 52 calculates a radiation efficiency of the optical output means 22, based on a power consumption measured by the power consumption measurement means 51 and intensity of excitation light measured by the excitation light measurement means 25. The second calculation means 53 calculates an excitation efficiency of the multicore EDF 14, based on first intensity, second intensity, and intensity of excitation light.

The connection means 23 connects between each of the optical output means 22 and each of the multicore EDFs 14, based on a radiation efficiency and an excitation efficiency.

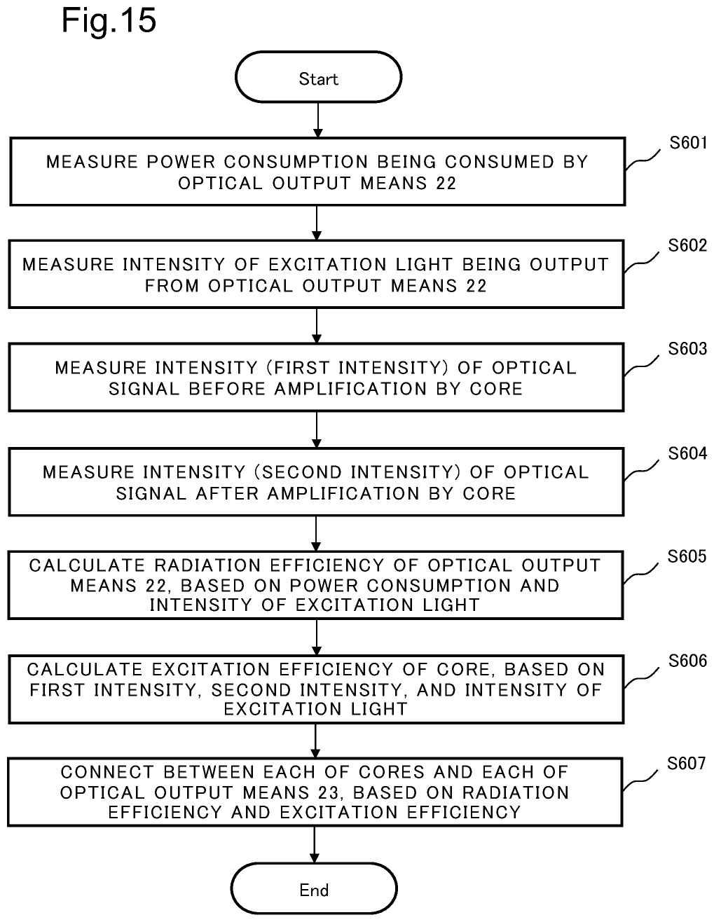

Next, an operation of the optical amplification system 6 is described by using FIG. 15. FIG. 15 is a flowchart illustrating an operation of the optical amplification system 6.

The power consumption measurement means 51 measures a power consumption being consumed by the optical output means 22 (S601). The excitation light measurement means 25 measures intensity of excitation light being output from the optical output means 22 (S602). The first optical signal measurement means 21 measures intensity (first intensity) of an optical signal before amplification by the core (S603). The second optical signal measurement means 24 measures intensity of an optical signal after amplification by the multicore EDF 14 (S604). Note that, order of the processing of S601 to S604 may be switched, or the processing of S601 to S604 may be performed in parallel.

The first calculation means 52 calculates a radiation efficiency of the optical output means 22, based on the power consumption and the intensity of the excitation light (S605). Further, the second calculation means 53 calculates an excitation efficiency of the core, based on the first intensity, the second intensity, and the intensity of the excitation light (S606). Note that, order of the processing of S605 and S606 may be switched, or the processing of S605 and S606 may be performed in parallel.

The controller 31 connects between each of the cores and each of the optical output means 22, based on the radiation efficiency and the excitation efficiency, based on the radiation efficiency and the excitation efficiency (S607).

As described above, the optical amplification system 6 includes the plurality of optical output means 22, the plurality of multicore EDFs 14, the power consumption measurement means 51, the excitation light measurement means 25, the first optical signal measurement means 21, the second optical signal measurement means 24, the first calculation means 52, the second calculation means 53, and the connection means 23.

In a general optical communication system, it is necessary to amplify all optical signals to equal to or more than predetermined intensity. Thus, when a core having a low excitation efficiency is connected to an optical output means having a low radiation efficiency, it is necessary to supply significantly large electric power to the optical output means in order to amplify an optical signal propagating through the core to predetermined intensity. Meanwhile, in the optical amplification system 1, the connection means 23 connects between each of the plurality of optical output means 22 and each of the plurality of cores, based on the radiation efficiency and the excitation efficiency. Thereby, the optical amplification system 1 can connect, for example, between one having a high radiation efficiency among the plurality of optical output means 22 and a core having a low excitation efficiency, and can connect between one having a low radiation efficiency among the plurality of optical output means 22 and a core having a high excitation efficiency. As a result, the optical amplification system 1 can reduce power consumption, since it is not necessary to supply significantly large electric power to one optical output means 22.

While the invention has been particularly shown and described with reference to exemplary embodiments thereof, the invention is not limited to these embodiments. It will be understood by those of ordinary skill in the art that various changes in form and details may be made therein without departing from the spirit and scope of the present invention as defined by the claims.

### REFERENCE SIGNS LIST

1, 1A, 2, 2A, 2B, 3, 4, 4A, 6 Optical amplification system
11, 11A, 11B, 11C Multiplexing means
12 Bundle fiber
13 Demultiplexer
14, 14A, 14B, 14C Multicore EDF
15 Bundle fiber
16, 16A, 16B, 16C Multiplexer
21 First optical signal measurement means
22 Optical output means
221 First optical output means
222 Second optical output means
223 Third optical output means
224 Fourth optical output means
22A, 22B, 22C, 22D Optical output means
23 Connection means
24 Second optical signal measurement means
25 Excitation light measurement means
30 Management unit
31 Controller
32 Power calculator
33 Efficiency calculator
34 Database
35 Update determination means
41 Optical output means for cladding
42 Multiplexer
50 Management unit
51 Power consumption measurement means
52 First calculation means
53 Second calculation means
100 Transmitter
200 Receiver
300 Line
400 Optical communication system

What is claimed is:

1. An optical amplification system comprising:
a plurality of optical output circuits configured to output excitation light;
a plurality of optical amplifiers configured to amplify an optical signal according to the excitation light;
a power consumption measurement circuit configured to measure power consumption being consumed by each of the plurality of optical output circuits;
an excitation light measurement circuit configured to measure intensity of the excitation light being output from each of the plurality of optical output circuits;
a first optical signal measurement circuit configured to measure first intensity of the optical signal before amplification by the optical amplifiers;
a second optical signal measurement circuit configured to measure second intensity of the optical signal after amplification by the optical amplifiers;
a first calculator configured to calculate a radiation efficiency of the optical output circuits, based on the power consumption and the intensity of the excitation light;
a second calculator configured to calculate an excitation efficiency of the optical amplifiers, based on the first intensity, the second intensity, and the intensity of the excitation light; and
a connection circuit configured to connect between each of the optical output circuits and each of the optical amplifiers, based on the radiation efficiency and the excitation efficiency.

2. The optical amplification system according to claim 1, wherein
the plurality of optical amplifiers include a core of a multicore optical fiber, and
the multicore optical fiber includes cladding that amplifies all of a plurality of the optical signals propagating through the plurality of optical amplifiers.

3. The optical amplification system according to claim 2, wherein
the connection circuit
connects between a first optical output circuit of the plurality of optical output circuits and a first optical amplifier of the plurality of optical amplifiers, and
connects between a second optical output circuit having the higher radiation efficiency than the first optical output circuit of the plurality of optical output circuits and a second optical amplifier having a lower amount of amplification by the cladding than the first optical amplifier of the plurality of optical amplifiers.

4. The optical amplification system according to claim 1, wherein
the connection circuit
connects between a third optical output circuit of the plurality of optical output circuits and a third optical amplifier of the plurality of optical amplifiers, and
connects between a fourth optical output circuit having the higher radiation efficiency than the third optical output circuit of the plurality of optical output circuits and a fourth optical amplifier having the lower excitation efficiency than the third optical amplifier of the plurality of optical amplifiers.

5. The optical amplification system according to claim 1, further comprising:
an additional optical output circuit being not connected to any of the plurality of optical amplifiers and being capable of outputting new excitation light; and
a multiplexer being capable of multiplexing and outputting, to any one of the plurality of optical amplifiers, the excitation light being output from the additional optical output circuit with the excitation light being output from any one of the plurality of optical output circuits, wherein
the connection circuit connects both of any one of the plurality of optical output circuits and the additional optical output circuit to any one of the plurality of optical amplifiers via the multiplexer,
the additional optical output circuit gradually rises the intensity of the excitation light being output, and
any one of the plurality of optical output circuits gradually decreases the intensity of the excitation light being output by the one of the plurality of optical output circuits, and stops outputting the excitation light.

6. The optical amplification system according to claim 5, further comprising
a database that stores a plurality of correlations between the power consumption each and the intensity of the excitation light each, wherein
the optical output circuits that has stopped outputting the excitation light among the plurality of optical output circuits outputs the excitation light again, and
the database updates the correlation, based on the power consumption being consumed by the optical output circuit and the intensity of the excitation light being output by the optical output circuit.

7. The optical amplification system according to claim 1, further comprising
a database that stores a plurality of correlations between the power consumption each and the intensity of the excitation light each, wherein,
the database updates the correlation, based on a change in the power consumption.

8. The optical amplification system according to claim 7, further comprising:
a transmission path propagating a plurality of the optical signals being output from a plurality of the optical amplifiers; and
a third optical signal measurement circuit being provided on the transmission path and configured to measure third intensity of the plurality of optical signals in the transmission path, wherein
the connection circuit updates a connection relationship between each of the optical output circuits and each of the optical amplifiers when the third intensity changes by equal to or more than a predetermined value.

9. The optical amplification system according to claim 1, wherein
two of the plurality of optical output circuits output the excitation light to a plurality of the optical amplifiers, by branching light being output from a single light source.

10. The optical amplification system according to claim 1, wherein
the optical output circuit outputs the excitation light to the optical amplifier, by multiplexing beams of light being output from a plurality of light sources.

11. The optical amplification system according to claim 1, wherein
the connection circuit is a matrix switch.

12. An optical amplification method comprising:
outputting excitation light by a plurality of optical output circuits;
amplifying an optical signal according to the excitation light by a plurality of optical amplifiers;
measuring power consumption being consumed by each of the plurality of optical output circuits;
measuring intensity of the excitation light being output from each of the plurality of optical output circuits;
measuring first intensity of the optical signal before amplification by the optical amplifiers;
measuring second intensity of the optical signal after amplification by the optical amplifiers;
calculating a radiation efficiency of the optical output circuits, based on the power consumption and the intensity of the excitation light;
calculating an excitation efficiency of the optical amplifiers, based on the first intensity, the second intensity, and the intensity of the excitation light; and
connecting between each of the optical output circuits and each of the optical amplifiers, based on the radiation efficiency and the excitation efficiency.

13. A tangible and non-transitory storage medium storing a program causing an information processing device to execute processing of:
outputting excitation light by a plurality of optical output circuits;
amplifying an optical signal according to the excitation light by a plurality of optical amplifiers;
measuring power consumption being consumed by each of the plurality of optical output circuits;
measuring intensity of the excitation light being output from each of the plurality of optical output circuits;
measuring first intensity of the optical signal before amplification by the optical amplifiers;
measuring second intensity of the optical signal after amplification by the optical amplifiers;
calculating a radiation efficiency of the optical output circuits, based on the power consumption and the intensity of the excitation light;
calculating an excitation efficiency of the optical amplifiers, based on the first intensity, the second intensity, and the intensity of the excitation light; and
connecting between each of the optical output circuits and each of the optical amplifiers, based on the radiation efficiency and the excitation efficiency.
